(19) United States
(12) Patent Application Publication
(10) Pub. No.: US 2015/0084816 A1
(43) Pub. Date: Mar. 26, 2015

(54) ELECTRONIC DEVICE

(71) Applicant: Kabushiki Kaisha Toshiba, Tokyo (JP)

(72) Inventors: Kengo Kurose, Hamura-shi (JP); Heiwa Matsuoka, Tachikawa-shi (JP); Ippei Kashiwagi, Ome-shi (JP); Tomohiro Wada, Tachikawa-shi (JP); Isao Okutsu, Akishima-shi (JP)

(73) Assignee: Kabushiki Kaisha Toshiba, Tokyo (JP)

(21) Appl. No.: 14/315,959

(22) Filed: Jun. 26, 2014

(30) Foreign Application Priority Data
Sep. 26, 2013 (JP) 2013-200281

(51) Int. Cl. H01Q 1/24; H01Q 1/52

(52) U.S. Cl. CPC H01Q 1/24; H01Q 1/526
USPC 343/702

(57) ABSTRACT

According to one embodiment, an electronic device includes a housing, an antenna, a first shield member, and a first spacer. The housing includes a first wall. The first wall includes an electromagnetic wave-transmissive material. The antenna is configured to overlap, in part, with the electromagnetic wave-transmissive material. The first shield member is located at a side of the antenna opposite the electromagnetic wave-transmissive material. The first spacer is located between the antenna and the first shield member.

### CROSS-REFERENCE TO RELATED APPLICATIONS

This application is based upon and claims the benefit of priority from Japanese Patent Application No. 2013-200281, filed Sep. 26, 2013, the entire contents of which are incorporated herein by reference.

### FIELD

Embodiments described herein relate generally to an electronic device.

### BACKGROUND

Conventionally, there is known an electronic device comprising an antenna provided inside a housing at an inner side of a wall and a shield member located at the side opposite the wall of the antenna.

It is preferable that such electronic device have a configuration capable of suppressing lowering of communication performance of the antenna, as an example.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view illustrating an example of an electronic device when viewed from the front side according to a first embodiment;

FIG. 2 is an exemplary cross-sectional view taken along line II-II of FIG. 1, in the embodiment;

FIG. 3 is an exemplary plan view illustrating a portion of one example of the electronic device in the vicinity of a first electromagnetic shield member in the embodiment;

FIG. 4 is an exemplary plan view illustrating a state in which the first electromagnetic shield member illustrated in FIG. 3 has been detached, in the embodiment;

FIG. 5 is an exemplary cross-sectional view illustrating one example of an electronic device according to a second embodiment;

FIG. 6 is an exemplary cross-sectional view illustrating one example of an electronic device according to a third embodiment; and

FIG. 7 is an exemplary cross-sectional view illustrating one example of an electronic device according to a fourth embodiment.

### DETAILED DESCRIPTION

In general, according to one embodiment, an electronic device comprises a housing, an antenna, a first shield member, and a first spacer. The housing comprises a first wall. The first wall comprises an electromagnetic wave-transmissive material. The antenna is configured to overlap, in part, with the electromagnetic wave-transmissive material. The first shield member is located at a side of the antenna opposite the electromagnetic wave-transmissive material. The first spacer is located between the antenna and the first shield member.

Hereinafter, described are embodiments with reference to the drawings. It is to be noted that the exemplary embodiments below comprise the same or similar constituent components. Hereinafter, common reference numerals denote the same or similar constituent components and overlapped description thereof is omitted.

Although the following embodiments describe the case where an electronic device is configured as a clamshell-type (notebook-type, folding-type) personal computer, the electronic device according to the embodiments is not limited thereto. Examples of the electronic device according to the embodiments may include tablet-type (slate-type) or desktop personal computers, smartphones, phablets, mobile phones, personal digital assistants (PDAs), electronic book terminals, video image display devices, television receivers, videophones, game machines, video image display controllers, information storage devices, and various electronic devices comprising an antenna and a circuit board.

### First Embodiment

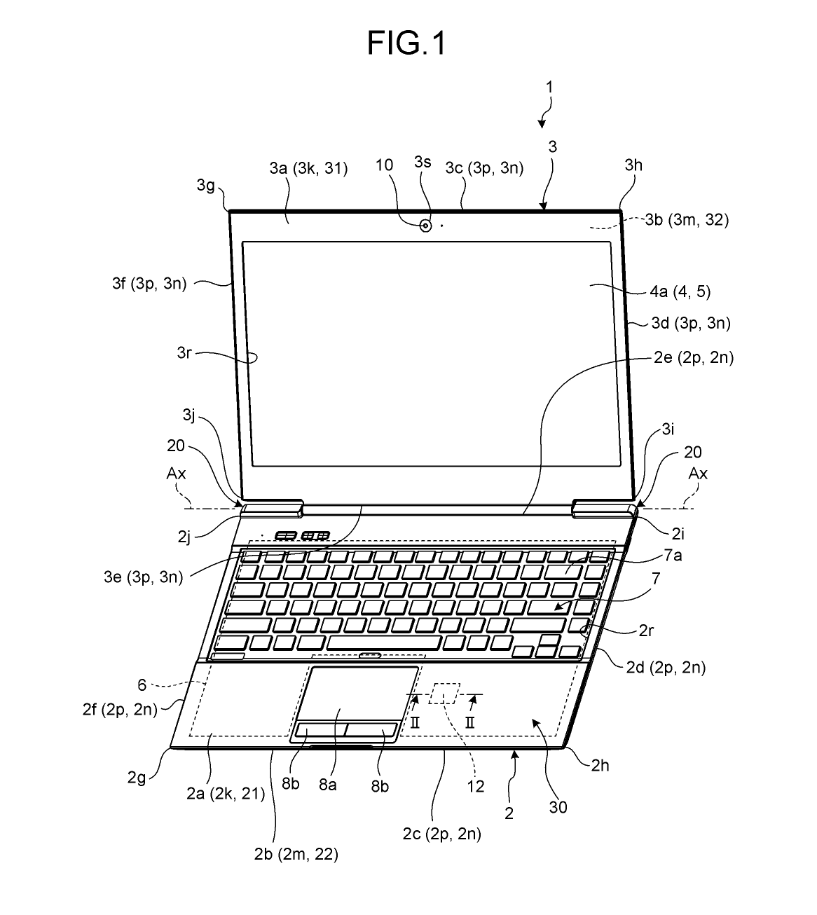

In the embodiment, as illustrated in FIG. 1, an electronic device 1 comprises a first housing 3 and a second housing 2, for example. To be specific, the first housing 3 supports a display device 4 (display module, display, panel). The first housing 3 is provided with a transparent touch panel 5 (touch sensor, input operation module, input receiver, input module) that overlaps the display device 4. A user and the like can visually check a video image (image) that is displayed on a display screen 4a of the display device 4 though the touch panel 5. Furthermore, the second housing 2 accommodates a substrate 6 (circuit board, control substrate, main substrate, electric component, first electric component). The second housing 2 is provided with a keyboard 7 (input operation module, first input operation module, input receiver, input module), a pointing device 8a (input operation module, second input operation module, input receiver, input module), click buttons 8b (input operation modules, input receivers, input modules), and the like.

The first housing 3 and the second housing 2 are connected to each other by hinge mechanisms 20 (hinges, connectors, connecting portions, rotational movement support portions, connecting mechanisms, connector mechanisms, rotational movement support mechanisms) in a rotationally movable manner. The first housing 3 and the second housing 2 are connected to each other in the rotationally movable manner between at least an opened state illustrated in FIG. 1 and a folded state (not illustrated) by the hinge mechanisms 20. In the embodiment, the hinge mechanisms 20 connect the first housing 3 and the second housing 2 in a rotationally movable manner about a rotating shaft Ax, as an example.

The display screen 4a of the display device 4 can be checked visually through an opening 3r provided on a face 3a (anterior face, upper face, front face, face portion) of the first housing 3. The keyboard 7, the pointing device 8a, the click buttons 8b, and the like are exposed to a face 2a (anterior face, upper face, front face, face portion) of the second housing 2. In the folded state, the face 3a of the first housing 3 and the face 2a of the second housing 2 are superimposed, so that the display screen 4a, the keyboard 7, the pointing device 8a, the click buttons 8b, and the like are hidden by the first housing 3 and the second housing 2. On the other hand, in the opened state, the face 3a of the first housing 3 and the face 2a of the second housing 2 are exposed, so that the display screen 4a, the keyboard 7, the pointing device 8a, the click buttons 8b, and the like can be used (can be checked visually or can be operated).

As illustrated in FIG. 1, the first housing 3 is configured to have a square shape (in the embodiment, rectangular shape, as an example) when seen from the front side and the rear side, as an example. The first housing 3 is configured to have a flattened rectangular parallelepiped shape that is thin in the front-rear direction. The first housing 3 comprises the face 3a and a face 3b (back face, lower face, rear face, face portion) at the side opposite the face 3a. Both the face 3a and the face 3b extend (are enlarged) in the direction intersecting with (in the embodiment, direction orthogonal to, as an example) the thickness direction of the first housing 3. The face 3a and the face 3b are substantially parallel with each other. Furthermore, as illustrated in FIG. 1, the first housing 3 comprises four ends 3c to 3f (sides, edges) and four corners 3g to 3j (sharp portions, bent portions, ends) when seen from the front side. The ends 3c and 3e are examples of long sides. The ends 3d and 3f are examples of short sides.

The first housing 3 comprises a wall 3k (plate, frame, anterior wall, front wall, ceiling wall) with the face 3a and a wall 3m (plate, rear wall, back wall, bottom wall) with the face 3b. The walls 3k and 3m have square shapes (in the embodiment, rectangular shapes, as an example). Furthermore, the first housing 3 comprises four walls 3n (plates, side walls, end walls, standing walls, connecting portions) with faces 3p (side faces, peripheral faces) connecting the wall 3k and the wall 3m. The wall 3k is provided with the square-shaped opening 3r, as an example. That is to say, the wall 3k has a square shape and a frame form.

Furthermore, the first housing 3 can be configured by combining a plurality of components (divided members). In the embodiment, the first housing 3 comprises a first housing member 31 (front member, mask, mask portion, cover, front cover, cover portion, first region) with at least the wall 3k and a second housing member 32 (rear member, base, base portion, bottom, bottom portion, cover, rear cover, cover portion, second region) with at least the wall 3m. The walls 3n are comprised by at least any one of the first housing member 31 and the second housing member 32 (for example, second housing member 32). Furthermore, the first housing 3 can be made of a metal material, a synthetic resin material, or the like.

The faces 3a, 3b, and 3p of the first housing 3 can be provided with a connector, an operation module, a camera module 10 (camera, image capturing device), and the like. The connector can be formed as a connector for a power supply cable, a universal serial bus (USB) connector, a card connector, or a connector of an earphone or a microphone, for example. The operation module can be formed as a press button, a press switch, a slide switch, a pointing device, or a dial, for example. It is to be noted that the camera module 10 is exposed through an opening 3s provided on the wall 3k of the first housing 3.

As illustrated in FIG. 1, the display screen 4a of the display device 4 that is located at the face 3a side is exposed to the front side (outer side) of the first housing 3 through the opening 3r. The user and the like can visually check the display screen 4a through the opening 3r from the front side. The display device 4 is configured to have a square shape (in the embodiment, rectangular shape, as an example) when seen from the front side. The display device 4 is configured to have a flattened rectangular parallelepiped shape that is thin in the front-rear direction. For example, the display device 4 is a liquid crystal display (LCD) or an organic electroluminescent display (OELD).

The touch panel 5 is provided at the posterior side (front side, wall 3k side) of the display device 4. The touch panel 5 is configured to have a square shape that is transparent and relatively thin and covers the display screen 4a. An operator (user and the like) performs an operation on the touch panel 5 with his (her) hand or finger, a component (for example, stylus, not illustrated), or the like so as to execute input processing. Examples of the operation to be performed by the operator include touching, pressing, sliding, or moving his (her) hand or finger, the stylus, or the like in the vicinity of the touch panel 5. Light emitted from the display screen 4a of the display device 4 passes through the touch panel 5 so as to travel to the front side (outer side) of the first housing 3 through the opening 3r of the wall 3k.

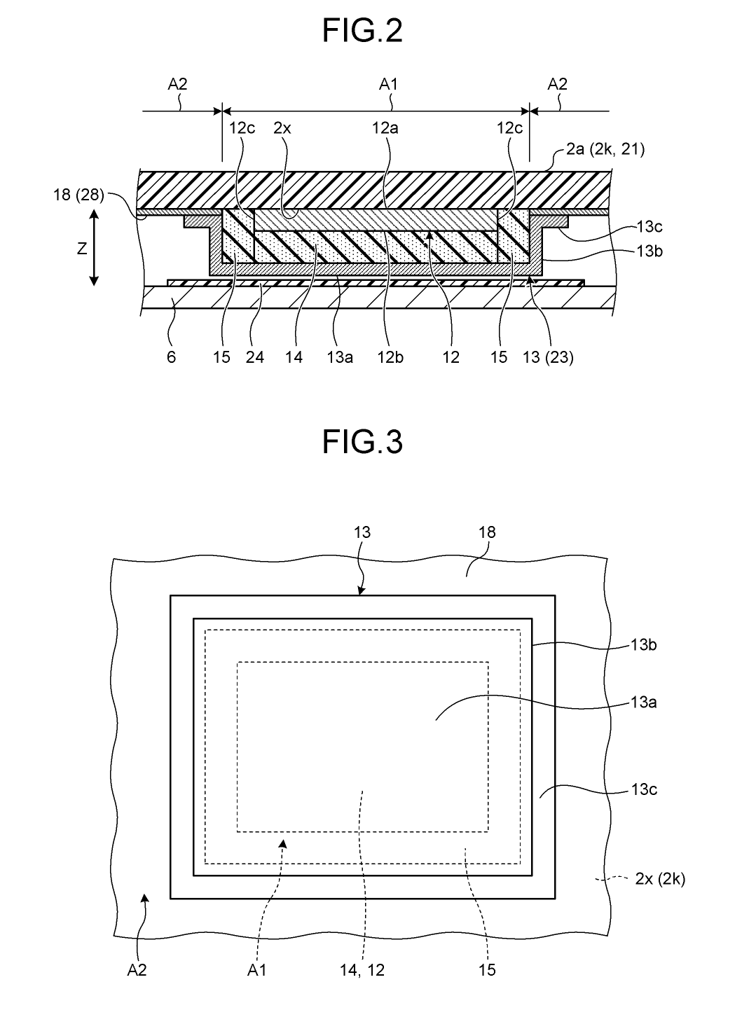

As illustrated in FIG. 1, the second housing 2 is configured to have a square shape (in the embodiment, rectangular shape, as an example) when seen from the front side and the rear side, as an example. The second housing 2 is configured to have a flattened rectangular parallelepiped shape that is thin in the front-rear direction. The second housing 2 comprises the face 2a and a face 2b (back face, lower face, rear face, face portion) at the side opposite the face 2a. Both the face 2a and the face 2b extend (are enlarged) in the direction intersecting with (in the embodiment, direction orthogonal to, as an example) the thickness direction (Z direction, see FIG. 2) of the second housing 2. The face 2a and the face 2b are substantially parallel with each other. Furthermore, the second housing 2 comprises four ends 2c to 2f (sides, edges) and four corners 2g to 2j (sharp portions, bent portions, ends) when the face 2a is seen from the front side. The ends 2c and 2e are examples of long sides. The ends 2d and 2f are examples of short sides.

The second housing 2 comprises a wall 2k (plate, frame, anterior wall, front wall, ceiling wall, first wall) with the face 2a and a wall 2m (plate, rear wall, back wall, bottom wall) with the face 2b. The walls 2k and 2m have square shapes (in the embodiment, rectangular shapes, as an example). Furthermore, the second housing 2 comprises four walls 2n (plates, side walls, end walls, standing walls, connecting portions) with faces 2p (sides, peripheral faces) connecting the wall 2k and the wall 2m. The wall 2k is provided with a square-shaped opening 2r, as an example. That is to say, the wall 2k has a square shape and a frame form. As illustrated in FIG. 1, when the second housing 2 is placed on a placement surface (flat surface), the wall 2k is located at the side opposite the placement surface.

As illustrated in FIG. 2, the wall 2k comprises a face 2x (inner face, inner side, face portion), a first portion A1, and a second portion A2. The face 2x corresponds to a face of the wall 2k at the side opposite the face 2a. The face 2x is provided in parallel with the face 2a. The first portion A1 corresponds to a portion (region) configured so as to transmit electromagnetic waves. The second portion A2 corresponds to a portion (region) configured so as to shield the electromagnetic waves. To be specific, in the embodiment, as an example, (the wall 2k of) the second housing 2 is made of a material (for example, synthetic resin material) having electromagnetic wave transmissivity. In addition, a film-like (or foil-like, thin plate-like) shield member 18 (second shield member, electromagnetic shield member) is provided on the face 2x that is a face of the wall 2k located inside the housing. The shield member 18 is configured as a separate body from the wall 2k along the wall 2k and covers the face 2x partially. The shield member 18 comprises a conductor portion 28 (second conductor, ground conductor). To be specific, the shield member 18 can be configured as a metal member (for example, sputtering layer) having conductivity. The first portion A1 corresponds to a portion (region) on which the wall 2k and the shield member 18 do not overlap with each other when viewed in the thickness direction (Z direction), that is, a portion (region) on which the shield member 18 is not provided. On the other hand, the second portion A2 correspond to a portion (region) on which the wall 2k and the shield member 18 overlap each other when viewed in the thickness direction (Z direction), that is, a portion (region) located to be deviated from the first portion A1.

As illustrated in FIG. 1, the second housing 2 can be configured by combining a plurality of components (divided members). In the embodiment, the second housing 2 comprises a first housing member 21 (front member, mask, mask portion, cover, front cover, cover portion, first region) with at least the wall 2k and a second housing member 22 (rear member, base, base portion, bottom, bottom portion, cover, rear cover, cover portion, second region) with at least the wall 2m. The walls 2n are comprised by at least any one of the first housing member 21 and the second housing member 22 (for example, second housing member 22).

Furthermore, in the embodiment, an operation face 7a (face, upper face) of the keyboard 7 is exposed to the front side (outer side) of the second housing 2 through the opening 2r, as an example. On the face 2a, the keyboard 7 is located to be closer to the end 2e side, and the pointing device 8a and the click buttons 8b are located to be closer to the end 2c side opposite the end 2e. The end 2e is located at the back side in the depth direction (direction along the ends 2d and 2f) and the end 2c is located at the front side. Palm rests 30 are provided at both the right and left sides (both sides in the direction along the ends 2c and 2e) of the pointing device 8a.

As illustrated in FIG. 1, the second housing 2 accommodates equal to or more than one substrate 6 at the rear side (back side, rear side, wall 2m side, side opposite the operation face 7a) of the keyboard 7. The substrate 6 is provided in parallel with the keyboard 7. The substrate 6 is provided so as to be separated from the walls 2k, 2m, 2n, and the like, that is, provided in a state in which spaces (intervals) are formed between the substrate 6 and the walls 2k, 2m, 2n, and the like.

For example, on the substrate 6, a plurality of components (not illustrated) such as a central processing unit (CPU), a graphic controller, a power supply circuit component, a platform controller hub (PCH), a memory slot connector, an LCD connector, an input/output (I/O) connecter, a power supply coil, an element, and a connector can be mounted. Furthermore, a control circuit can comprise a video image signal processing circuit, a tuner module, a high-definition multimedia interface (HDMI, registered trademark) signal processor, an audio video (AV) input terminal, a remote control signal receiver, a controller, a selector, an on-screen display interface, a storage module (for example, read only memory (ROM), random access memory (RAM), hard disk drive (HDD), solid state drive (SSD)), and an audio signal processing circuit, for example. The control circuit controls output of a video image (moving image, still image, and the like) from the display screen 4a of the display device 4, output of audio from a speaker (not illustrated), light emission from a light emitting diode (LED, not illustrated), and the like. The display device 4, the speaker, the LED, and the like are examples of an output module.

In the embodiment, an antenna 12 (electric component, second electric component) is provided in the second housing 2, as an example. For example, the antenna 12 can be formed as a near field communication (NFC) antenna, a planar antenna, a coil antenna, or the like.

As illustrated in FIGS. 1 and 2, at least a portion of the antenna 12 overlaps with the first portion A1 provided on the palm rest 30 at the inner side of the wall 2k (inner side of the second housing 2), as an example. To be specific, the antenna 12 is fixed (bonded) to the face 2x of the first portion A1 with an adhesion portion (for example, double-stick tape, adhesive). In this manner, the antenna 12 overlaps the first portion A1 which is configured to transmit electromagnetic waves so as to perform data communication through the first portion A1. As an example, when the antenna 12 is configured as the NFC antenna, a terminal device such as an IC card is held on the antenna 12 from the outer side (outer side of the second housing 2) of the first portion A1 of the wall 2k so as to make communication (for example, near field communication (NFC)) between the terminal device and the control circuit that is electrically connected to the antenna 12.

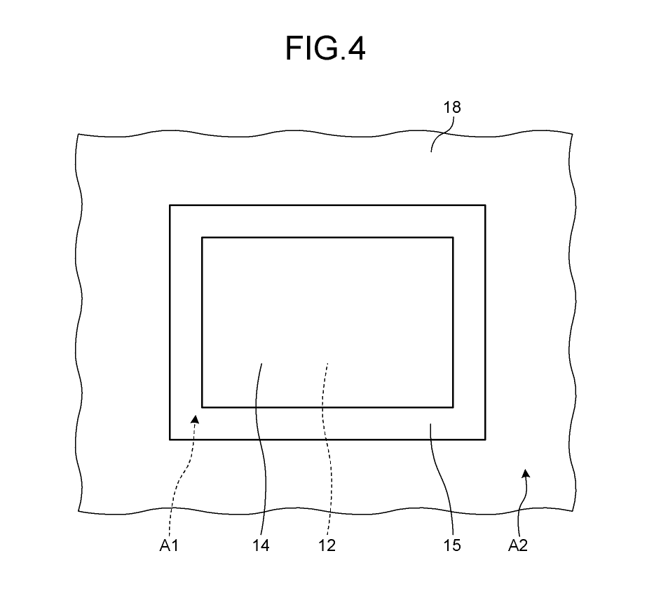

As illustrated in FIGS. 2 and 4, the antenna 12 has a square shape (in the embodiment, rectangular shape, as an example) when viewed from the above and is configured to have a flattened rectangular parallelepiped (plate-like) shape, as an example. The antenna 12 comprises a face 12a (anterior face, upper face, front face, face portion) that is fixed (bonded) to the face 2x and a face 12b (posterior face, lower face, rear face, face portion) at the side opposite the face 12a. Both the face 12a and the face 12b extend (are enlarged) along the direction intersecting with (in the embodiment, direction orthogonal to, as an example) the thickness direction (Z direction) of the second housing 2. The face 12a and the face 12b are substantially parallel with each other. Furthermore, the antenna 12 comprises four faces 12c (side faces, peripheral faces) connecting the face 12a and the face 12b with each other.

In the embodiment, a shield member 13 (first shield member, electromagnetic shield member) is provided on the antenna 12 at the side opposite the wall 2k (first portion A1), as an example. The shield member 13 comprises a conductor 23 (first conductor).

To be specific, the shield member 13 is formed by a sheet-like (deformable) metal member (for example, aluminum sheet, aluminum foil, aluminum tape) having conductivity and flexibility. Furthermore, the substrate 6 (circuit board) is provided on the shield member 13 at the side opposite the antenna 12. That is to say, the shield member 13 is located between the antenna 12 and the substrate 6. Thus, the shield member 13 is interposed between the antenna 12 and an electric component (in the embodiment, substrate 6 as an example) different from the antenna 12 that is accommodated in the second housing 2. This suppresses interference between electromagnetic waves of the electric component and electromagnetic waves of the antenna 12 (interactive interference between the electric component and the antenna 12). It is to be noted that a film-like (thin plate-like) insulating member 24 (for example, insulator) suppressing the conduction between the shield member 13 and the substrate 6 is provided therebetween.

As illustrated in FIGS. 2 and 3, the shield member 13 comprises a first shield 13a, a second shield 13b, and a fixing portion 13c (portion), as an example. The first shield 13a extends along the direction intersecting with (in the embodiment, direction orthogonal to, as an example, the direction substantially parallel with the wall 2k) the thickness direction (Z direction) of the second housing 2 and covers the antenna 12 at the side opposite the first portion A1. The second shield 13b extends along the direction (in the embodiment, thickness direction of the second housing 2, Z direction, as an example) intersecting with the wall 2k and covers a periphery of the antenna 12. The fixing portion 13c is located on the second shield 13b at the side opposite the antenna 12. The fixing portion 13c extends along the direction intersecting with (in the embodiment, direction orthogonal to, as an example, the direction substantially parallel with the wall 2k) the thickness direction (Z direction) of the second housing 2. The first shield 13a, the second shield 13b, and the fixing portion 13c are configured integrally and are electrically connected to one another.

In the embodiment, a spacer 14 (first spacer) is provided between the antenna 12 and (the first shield 13a of) the shield member 13, as an example. As illustrated in FIGS. 2 to 4, the spacer 14 has a square shape (in the embodiment, rectangular shape as an example) having substantially the same size as the antenna 12 when viewed from the above and is configured to have a flattened rectangular parallelepiped (plate-like) shape. The spacer 14 covers substantially the overall region of the (face 12b of the) antenna 12. Furthermore, the spacer 14 is fixed (bonded) to the (face 12b of the) antenna 12 or (the first shield 13a of) the shield member 13 with an adhesion (for example, double-stick tape, adhesive). The spacer 14 can be formed by an elastic member (in the embodiment, sponge (foam material), as an example) that is non-conductive (non-conductor) and is relatively light. The spacer 14 is interposed between the antenna 12 and (the first shield 13a of) the shield member 13 in this manner. This can prevent a problem that the antenna 12 or the first shield 13a is deformed or moved and the first shield 13a and the antenna 12 make closer to each other from occurring, for example. According to the embodiment, a distance between the antenna 12 and the first shield 13a is easy to be kept, so that lowering of the communication performance of the antenna 12 is easy to be suppressed, as an example. In addition, the spacer 14 is provided, so that the distance between the antenna 12 and the first shield 13a is easy to be kept even when the shield member 13 is formed by a film of aluminum alloy having relatively high flexibility (that is easy to be deformed), or the like. With this, the shield member 13 is easy to be configured at lower cost, as an example.

Furthermore, in the embodiment, a spacer 15 (second spacer) is provided between the antenna 12 and the second shield 13b, as an example. As illustrated in FIGS. 2 to 4, the spacer 15 is formed into a frame (in the embodiment, square frame form) surrounding the antenna 12. The spacer 15 covers substantially the overall region of the periphery of the antenna 12. The spacer 15 is fixed (bonded) to the wall 2k (face 2x of the wall 2k), (the faces 12c) of the antenna 12, or (the second shield 13b of) the shield member 13 with an adhesion (for example, double-stick tape, adhesive). The spacer 15 can be formed by an elastic member (for example, sponge (foam material) that is non-conductive (conductor) and is relatively light in the same manner as the spacer 14. The spacer 15 is interposed between the antenna 12 and the second shield 13b in this manner. This can prevent a problem that the antenna 12 or the second shield 13b is deformed or moved and the second shield 13b and the antenna 12 make closer to each other from occurring, for example. According to the embodiment, a distance between the antenna 12 and the second shield 13b is easy to be ensured, so that lowering of communication performance of the antenna 12 is easy to be suppressed by the second shield 13b, as an example. In addition, the spacer 15 is provided, so that the distance between the antenna 12 and the second shield 13b is easy to be kept even when the shield member 13 is formed by a film of aluminum alloy having relatively high flexibility (that is easy to be deformed), or the like. With this, the shield member 13 is easy to be configured at lower cost, as an example.

In the embodiment, the fixing portion 13c (portion located at the periphery side of the antenna 12) of the shield member 13 is fixed to the face 2x side (placement surface side) of the wall 2k, as an example. That is to say, the shield member 13 is made into a state of being suspended upside down from the wall 2k provided with the palm rest 30 in the state (posture) where the electronic device 1 is placed on the placement surface. The shield member 13 deflects in the direction of being separated from the antenna 12 with a gravity force, as an example. This can further separate (the first shield 13a of) the shield member 13 and the antenna 12 from each other (further prevent the first shield 13a and the antenna 12 from making closer to each other).

The fixing portion 13c is connected (bonded) to the shield member 18 through a conductive adhesion layer (for example, double-stick tape containing a conductive filler, not illustrated). When the shield member 13 is not electrically grounded and is in a floating state, there is a risk that electromagnetic noise is transferred through the shield member 13. In this point, according to the embodiment, the fixing portion 13c of the shield member 13 is electrically connected (ground-connected) to the shield member 18, so that shielding property of the shield member 13 is easy to be enhanced.

As described above, in the embodiment, the spacer 14 (first spacer) is interposed between the antenna 12 and the shield member 13 (first shield member), as an example. According to the embodiment, the spacer 14 is easy to keep the state where the shield member 13 and the antenna 12 are separated from each other, as an example. This makes it easy to suppress lowering of the communication performance of the antenna 12, as an example.

In addition, in the embodiment, the spacer 14 (first spacer) is configured to have substantially the same size as the antenna 12, as an example. That is to say, the spacer 14 covers substantially the overall region of the face 12b of the antenna 12. With this, according to the embodiment, the distance between the shield member 13 and the antenna 12 is easy to be constant in comparison with the configuration in which the spacer 14 covers the face 12b of the antenna 12 partially, as an example. This makes it easy to suppress lowering of the communication performance of the antenna 12, as an example.

In the embodiment, the shield member 13 (first shield member) comprises the first shield 13a located on the antenna 12 at the side opposite the first portion A1 and the second shield 13b located on the periphery of the antenna 12, as an example. According to the embodiment, the first shield 13a can cover the antenna 12 at the side opposite the first portion A1 and the second shield 13b can cover the periphery of the antenna 12, as an example. This makes it easy to suppress interactive interference between the electromagnetic waves of the antenna 12 and the electromagnetic waves of the electric component (for example, substrate 6) located on the shield member 13 at the side opposite to the antenna 12, as an example.

Furthermore, in the embodiment, the spacer 15 (second pacer) is interposed between the antenna 12 and the second shield 13b, as an example. According to the embodiment, lowering of the communication performance of the antenna 12 is easier to be suppressed, as an example. It is to be noted that a slight space may be provided between the spacer 15 and the second shield 13b or between the spacer 15 and the antenna 12.

In the embodiment, the spacer 15 (second spacer) is formed into a frame surrounding the antenna 12, as an example. According to the embodiment, the distance between the antenna 12 and (the second shield 13b of) the shield member 13 is easy to be kept constant on the periphery of the antenna 12, as an example. This makes it easier to suppress lowering of the communication performance of the antenna 12, as an example.

In the embodiment, the fixing portion 13c (portion located at the peripheral edge side of the antenna 12) of the shield member 13 is fixed to the face 2x side (placement surface side) of the wall 2k, as an example. According to the embodiment, (the first shield 13a of) the shield member 13 can be separated from the antenna 12 with a gravity force in the state where the electronic device 1 is placed on the placement surface (flat surface), as an example. This makes it easier to suppress lowering of the communication performance of the antenna 12, as an example. Furthermore, only the fixing portion 13c is fixed to the wall 2k side, as an example. This can easily suppress a problem that construction cost of the electronic device 1 is increased and the manufacturing processing of the electronic device 1 is complicated in comparison with the configuration in which the first shield 13a and the second shield 13b are further fixed to the spacers 14 and 15, respectively, with an adhesion portion (for example, double-stick tape, adhesive). It is to be noted that a slight space may be provided between the spacer 14 and (the first shield 13a) of the shield member 13 or between the spacer 14 and the antenna 12 in a state where the electronic device 1 is placed on the placement surface (flat surface).

Furthermore, in the embodiment, at least one of the spacer 14 (first spacer) and the spacer 15 (second spacer) (in the embodiment, both of them, as an example) is formed by an elastic member, as an example. According to the embodiment, elastic repulsion forces of the spacers 14 and 15 are easy to prevent the antenna 12 and the shield member 13 from making closer to each other. In addition, according to the embodiment, the electronic device 1 is easy to be made light, as an example. Although the spacers 14 and 15 overall are formed by the elastic member in the embodiment, at least a part of the spacers 14 and 15 may be formed by the elastic member. That is to say, the spacers 14 and 15 may comprise (include or have) an elastic member.

Furthermore, in the embodiment, at least one of the spacer 14 (first spacer) and the spacer 15 (second spacer) (in the embodiment, both of them, as an example) is formed by a sponge, as an example. According to the embodiment, the electronic device 1 is easier to be made light, as an example. It is to be noted that although the elastic member constituting the spacers 14 and 15 is formed by a sponge (foam material) in the embodiment, the elastic member may be formed by an elastomer, a synthetic resin material, a silicon resin material, or the like.

Furthermore, in the embodiment, the shield member 13 (first shield member) is formed into a deformable sheet, as an example. According to the embodiment, the fixing portion 13c is fixed to the wall 2k side, (the first shield 13a of) the shield member 13 is made into a state of being suspended from the wall 2k, as an example. With this, the shield member 13 is easy to be separated from the antenna 12 with the gravity force. This makes it easier to suppress lowering of the communication performance of the antenna 12, as an example. In addition, the shield member 13 is easy to be configured to be lighter at lower cost and the shield member 13 is easy to be attached by adhesion or the like more easily in comparison with the configuration in which the shield member 13 is formed by a hard metal plate or the like, as an example.

In the embodiment, the substrate 6 (circuit board) that overlaps with the shield member 13 (first shield member) and the shield member 18 (second shield member) in the thickness direction (Z direction) is provided, as an example. That is to say, the shield member 13 is located between the antenna 12 and the substrate 6. According to the embodiment, interactive interference between the electromagnetic waves of the substrate 6 and the electromagnetic waves of the antenna 12 is easy to be suppressed, as an example.

In the embodiment, the conductor 23 (first conductor portion) of the shield member 13 (first shield member) and the conductor 28 (second conductor) of the shield member 18 (second shield member) are electrically connected to each other, as an example. According to the embodiment, the shield member 13 is prevented from being made into a state where it is not grounded and floats, so that the shielding property of the shield member 13 is easy to be further enhanced, as an example.

### Second Embodiment

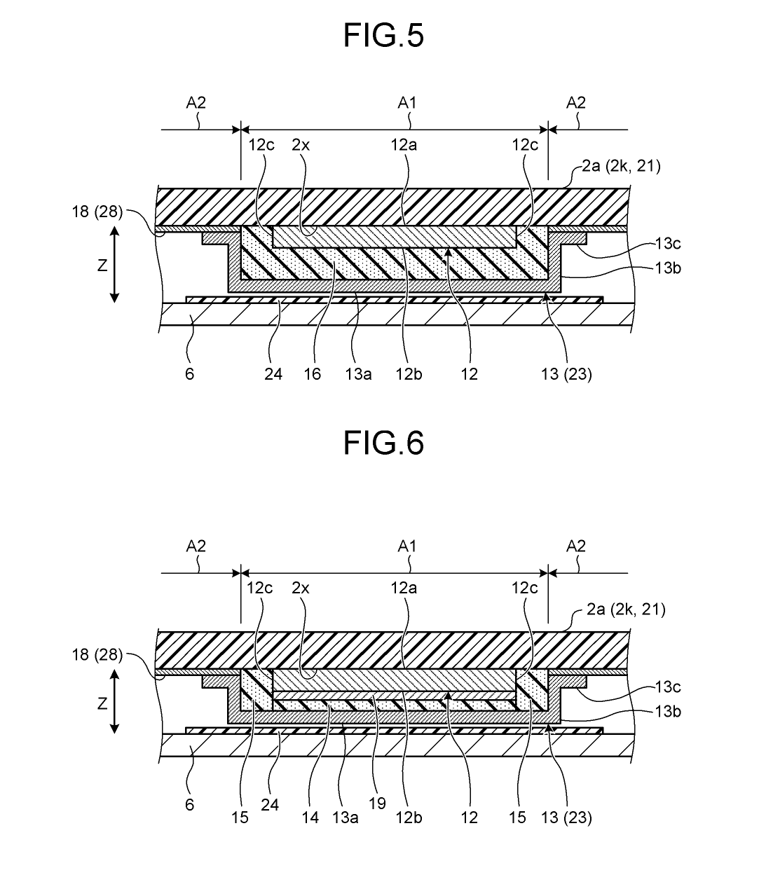

The electronic device 1 according to the embodiment as illustrated in FIG. 5 has the same or similar configuration as the electronic device 1 according to the above-mentioned embodiment. Accordingly, the embodiment can also obtain the same results (effects) based on the same or similar configuration as that in the above-mentioned embodiment.

Note that in the embodiment, as illustrated in FIG. 5, a spacer 16 comprises the spacer 14 (first spacer, see FIG. 2) and the spacer 15 (second spacer, see FIG. 2), as an example. That is to say, the spacer 16 has a configuration in which the spacer 14 (first spacer) and the spacer 15 (second spacer) are integrated with each other. The spacer 16 is fixed to the face 12b of the antenna 12 and the face 2x of the first portion A1 with an adhesive portion (for example, double-stick tape, adhesive). Furthermore, the spacer 16 can be formed by an elastic member (for example, sponge (foam material)) that is non-conductive (non-conductor) and is relatively light. According to the embodiment, a troublesome effort for an operation of attaching the spacer 16 to the antenna 12 and the wall 2k is easy to be reduced in comparison with the case where the spacer 14 (first spacer) and the spacer 15 (second spacer) are configured as separate bodies, as an example. Although the thickness of the portion of the spacer 16 that is superimposed with the antenna 12 and the thickness of the portion thereof that is located on the peripheral edge of the antenna 12 are different from each other in the embodiment, the thickness of the spacer 16 may be constant. The same applies to the spacer 14 (first spacer) and the spacer 15 (second spacer) in the above-mentioned first embodiment.

### Third Embodiment

The electronic device 1 according to the embodiment as illustrated in FIG. 6 has the same or similar configuration as the electronic device 1 according to the above-mentioned embodiment. Accordingly, the embodiment can also obtain the same results (effects) based on the same or similar configuration as that in the above-mentioned embodiment.

Note that in the embodiment, as illustrated in FIG. 6, a shield member 19 (third shield member) is provided between the antenna 12 and the first shield 13a, as an example. To be specific, the shield member 19 is located between the antenna 12 and the spacer 14 (first spacer), as an example. The shield member 19 is configured to have substantially the same size as the antenna 12 and cover substantially the overall region of (the face 12b of) the antenna 12. The shield member 19 can be formed by a sheet-like magnetic member (for example, ferrite sheet). According to the embodiment, the shield member 19 (third shield member) formed by a magnetic member enables the shield member 13 (first shield member) to be located at a position closer to the antenna 12 in comparison with the configuration in the above-mentioned first embodiment, as an example. With this, the thickness of the second housing 2 is easy to be made thinner, as an example. It is to be noted that although the shield member 19 is provided between (the face 12b) of the antenna 12 and the spacer 14 (first spacer) only in the embodiment, it may be further provided between (the surfaces 12c) of the antenna 12 and the spacer 15 (second spacer).

### Fourth Embodiment

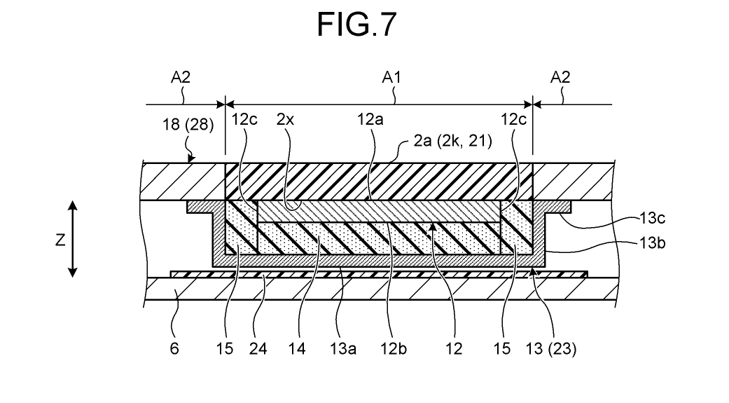

The electronic device 1 according to the embodiment as illustrated in FIG. 7 has the same or similar configuration as the electronic device 1 according to the above-mentioned embodiment. Accordingly, the embodiment can also obtain the same results (effects) based on the same or similar configuration as that in the above-mentioned embodiment.

Note that in the embodiment, as illustrated in FIG. 7, (the wall 2k) of the second housing 2 is made of a metal material (conductive material, conductor, for example, magnesium alloy) and at least a part of the wall 2k is made of a synthetic resin material (non-conductive material, non-conductor), for example, by two-color molding or the like, as an example. That is to say, in the embodiment, the shield member 18 (second shield member) is configured integrally with the wall 2k. In the embodiment, a portion of the wall 2k that is made of a synthetic resin material corresponds to the first portion A1 and a portion of the wall 2k that is made of a metal material corresponds to the second portion A2. With this, according to the embodiment, the first portion A1 and the second portion A2 are easy to be molded more easily in comparison with the configuration in which the shield member 18 as a separate body from the wall 2k is provided on the face 2x of the wall 2k, as an example.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a housing comprising a first wall, the first wall comprising an electromagnetic wave-transmissive material;
an antenna configured to overlap, in part, with the electromagnetic wave-transmissive material;
a first shield member located at aside of the antenna opposite the electromagnetic wave-transmissive material; and
a first spacer located between the antenna and the first shield member.

2. The electronic device of claim 1, wherein the first shield member comprises:
a first shield located at a side of the antenna opposite the electromagnetic wave-transmission material and intersecting with a thickness direction of the first wall; and
a second shield located at a periphery of the antenna when viewed in the thickness direction of the first wall, is connected to the first shield, and configured to extend along the thickness direction.

3. The electronic device of Claim. 2, further comprising a second spacer located between the antenna and the second shield.

4. The electronic device of claim 3, wherein the second spacer is configured to surround the antenna.

5. The electronic device of claim 3, wherein the first spacer and the second spacer are configured integrally.

6. The electronic device of claim 1, wherein,
when the housing is placed on a flat face, the first wall is located at a side opposite the flat face, and
a part of the first shield member located at a periphery side of the antenna when viewed in a thickness direction of the first wall is fixed to the first wall at a side of the flat face.

7. The electronic device of claim 1, further comprising a second shield member located off from the electromagnetic wave-transmission material when viewed in the thickness direction of the first wall, and is configured integrally with the first wall or is configured as a separate body from the first wall while extending along the first wall.

8. The electronic device of claim 7, further comprising a circuit board provided inside the housing and overlapping the first shield member and the second shield member in the thickness direction.

9. The electronic device of claim 7, wherein
the first shield member comprises a first conductor,
the second shield member comprises a second conductor, and
the first conductor and the second conductor are electrically connected with each other.

10. The electronic device of claim 1, wherein at least one of the first spacer and the second spacer comprises an elastic member.

11. The electronic device of claim 10, wherein the elastic member is a sponge.

12. The electronic device of claim 1, wherein the first shield member is formed as a deformable sheet.

13. The electronic device of claim 2, further comprising a third shield member located between the antenna and the first shield portion.

14. The electronic device of claim 13, wherein the third shield member comprises a sheet-like magnetic member.
